(19) United States
(12) Patent Application Publication
(10) Pub. No.: US 2018/0022961 A1
(43) Pub. Date: Jan. 25, 2018

(54) ADHESIVE TAPE, PARTICULARLY WRAPPING TAPE

(71) Applicant: Certoplast Technische Klebebaender GmbH, Wuppertal (DE)

(72) Inventor: Timo LEERMANN, Wuppertal (DE)

(21) Appl. No.: 15/540,758

(22) PCT Filed: Jan. 13, 2016
(86) PCT No.: PCT/EP2016/000046

§ 371 Date: Jun. 29, 2017

(30) Foreign Application Priority Data
Jan. 13, 2015 (DE) 20 2015 100 125.8

(51) Int. Cl. C09J 7/02; C09J 5/00; C09J 7/04

(52) U.S. Cl. CPC C09J 7/02; C09J 7/04; C09J 5/00; C09J 2203/302; C09J 2400/263

(57) ABSTRACT

The invention relates to an adhesive tape, particularly wrapping tape, for wrapping elongate objects (2), such as for example cable bundles (2) in automobiles, comprising a support (3, 4), an adhesive coating (5) applied to one side or both sides, and a marking (6). The marking (6) is designed as a positioning aid during wrapping, and specifically in such a way that a follow-up wrap (8 or 9, 10) is glued with an overlap (A), which is defined by a predefined positioning aid (6), on a leading wrap (7 or 8, 9) that is in each case solidly glued on the object (2).

The invention relates to an adhesive tape, particularly tape for wrapping an elongated object such as for example a cable bundle in a car with a substrate comprising an adhesive coating applied to one or both faces, and with a marking.

An adhesive tape particularly for wrapping an elongated object such as a cable bundle in a car is described in detail inter alia in utility model DE 94 00 574. One can also see in FIG. 4 of that document how a wiring harness or cable bundle is or can be wrapped with the described adhesive tape. In fact, this procedure is still carried out manually to this day, because the cable bundles to be grouped together for use in an automobile are ultimately unique. This can be attributed to the different equipment variants, different specifications for domestic and abroad, etc.

During this wrapping process, the procedure is typically such that the adhesive tape is wound helically around the cable bundle in this embodiment. Each turn is adhered to a preceding or leading turn with a defined and ultimately freely selectable overlap. This overlap is ultimately predefined by the assembly worker based on his own or others' experiences. As a result of this, one encounters overlaps that are more or less pronounced, overlaps that alternate, etc. The adhesive tapes and particularly wrapping tapes used in this context for wrapping a cable bundle in a car must satisfy different requirements. One important aspect, for example, is that they be insensitive to fuel, oil, or comparable media. Moreover, the desire is that such adhesive tapes have a positive influence on the noise generation of a cable set or cable bundle and particularly that rattling noises be dampened acoustically as effectively as possible.

In this regard, the prior art according to EP 1 754 764 proposes an adhesive tape having a textile substrate made of at least one fabric layer and one flat web joined thereto. Of course, this inflates the manufacturing costs of such adhesive tapes.

For this reason, there is a desire to keep the production costs of the adhesive tape used as low as possible. At the same time, an attempt is made to improve the manufacturing process for cable sets and particularly the wrapping of cable bundles in this embodiment. However, there have not been any satisfying approaches in this regard to date. It is true that the generic prior art according to DE 20 2010 016 142 describes an adhesive tape that is additionally outfitted with a marking. However, the known adhesive tape is provided on only one face with an adhesive layer and also carried the adhesive layer only partially over its width.

Manufacturing costs are positively influenced in this way simply because of the adhesive saved. However, the wrap or cable binding produced in this way is not (or is no longer) able to properly immobilize the individual cables of the cable bundle and secure them against one another. Instead, one is expressly expected to proceed such that, while the cable harness is enclosed and thus protected sufficiently against external influences, it is not joined with a possibly stiffening adhesive compound.

Although this might increase the overall flexibility of the cable harness or wiring loom, such a loose encasement, as it were, brings with it the danger of it being shifted relative to the cable bundle or torn or stripped off entirely from the wrapped cable bundle. What is more, noise-attenuating measures and corresponding outfitting for the noise-attenuating of the adhesive tape cannot be effectively implemented as a result.

After all, this presupposes a secure connection of the adhesive tape to the wrapped cable bundle in order to make the required sound-absorbing effect available. However, any spacing or even loose wrapping of the adhesive tape on the wrapped cable bundle has the effect that rattling noises of the cable bundle or cable harness equipped in this way cannot be controlled, or at least not effectively. Moreover, such a loose wrapping is hardly capable of protecting the commensurately equipped cable set or cable bundle mechanically from shearing stresses, sharp edges, etc. It is in this regard that the invention as a whole aims to provide a remedy.

The object of the invention is to further develop such an adhesive tape that its special suitability as wrapping tape for wrapping in cable bundles in a car remains intact while achieving cost advantages during processing.

To attain this object, a generic adhesive tape is characterized in the context of the invention in that the marking is a positioning aid during wrapping, particularly in such a way that a following turn with an overlap predefined by the positioning aid is glued to a leading or preceding turn glued securely on the object.

Accordingly, the adhesive tape according to the invention is wrapped in the manner of a spiral or helix around the elongated object or preferably the cable bundle in a car. The leading or preceding turn is glued securely on the object or, more precisely, the cable bundle. The subsequent following turn is then glued on the leading turn with a defined overlap. In order to specify this overlap, or to set it as defined according to the invention, the adhesive tape is equipped with the marking a positioning aid during wrapping.

In fact, the overall procedure is such that the marking is generally provided on an outer face of the adhesive tape facing away from the object or cable bundle, so that it acts and also can act as the above-mentioned positioning aid for the assembly worker. On the other hand, an inner face of the adhesive tape has the adhesive coating that, as a result, faces toward the object. Usually, the assembly worker will orient himself on the basis of the marking such that he can guide the following turn with the rear edge of the adhesive tape (when seen in the wrapping direction) along the marking serving as positioning aid.

In this way, not only is the wrapping process as such rendered uniform because the positioning aid in question is available for the rear edge of the turn or adhesive tape (when seen in the wrapping direction), but rather the degree of overlap between the leading turn and the following turn can also be optimized. To wit, one does in fact encounter degrees of overlap that are generally substantially greater than is necessary in order to achieve the requisite protection for the cable bundles as well as the other positive effects of a cable set equipped in this way, for example in terms of noise attenuation.

In practice, a degree of overlap of about 50% or even more is usually used. That is, the following turn overlaps with the leading turn by approximately half of the width of the adhesive tape. According to the invention, this overlap can now be set substantially lower. This is achieved by having the spacing of the marking from a covered edge be 50% or less of the width of the substrate. Usually, it is even possible to work with a spacing of the marking from the covered edge in question of 30% or less. That is, by virtue of the marking a positioning aid, not only is the wrapping and consequently the wrapping outcome rendered uniform according to the invention, but it is also possible to turn a substantially longer area of cable bundles in this embodiment using an adhesive tape of the same length as in the prior art, thereby significantly reducing the overall consumption of material.

This, of course, also results in reduced costs. In fact, savings of at least 10% and typically of even greater than 20% are observed, because the marking designed as a positioning aid not only reduces the overlap to a minimum while rendering the wrapping process uniform but also increases the speed of the assembly worker during the wrapping process. Herein lie the fundamental advantages.

According to an advantageous embodiment, the substrate is provided with the adhesive coating over its entire surface. In principle, however, an adhesive coating can also be used that is applied to the substrate as a strip, as long as one ensures that the individual turns are securely glued to the object or, more specifically, to the cable bundle to be wrapped. This is important because the substrate can, in principle, have any conceivable structure; according to an advantageous embodiment, however, it is a textile substrate made of at least one woven fabric layer and a flat web connected thereto. The flat web can be a warp-knitted fabric or also a nonwoven fabric or even a velours.

In any case, such a substrate and an adhesive tape equipped in this way is characterized simultaneously by good mechanical stability and outstanding noise attenuation. This presupposes, however, that the adhesive tape is glued securely on the elongated object as described so that the flat web can exercise its noise-attenuating effect. That is not possible with a loose wrapping according to the generic prior art according to DE 20 2010 016 142, not least because relative movement is also permitted between the adhesive tape and the wrapped cable bundle.

According to an advantageous embodiment, the substrate is provided with the adhesive coating on its inner face facing toward the object. By contrast, its outer face facing away from the object has the previously mentioned marking stripe that acts as a positioning aid during wrapping. In this connection, the marking is consistently placed on the substrate. Alternatively or in addition, however, the marking can also be worked into the substrate. For example, if the substrate is a fabric substrate or the substrate has a woven fabric layer, the marking can be implemented and realized in practice as a woven-in warp yarn or continuous sewing thread. Generally, the overall approach taken here is to have the marking be a colored mark and for it to have a coloring that is different from a substrate color, particularly a contrasting coloring. For example, if the substrate has a black color, the marking can be designed as a colored stripe with a contrasting color, for example as a red warp yarn in the example of a fabric substrate or a woven fabric layer.

Beside such a visual design of the marking, it is also possible for the mark to be alternatively or additionally a haptic marking. In this case, the marking is (additionally) perceived by the assembly worker using his sense of touch. For this purpose, the implemented haptic mark typically has a feel that differs from a surface quality of the substrate. In the simplest of cases, this can be achieved by having the mark have the appearance of a raised area, nub, etc., in comparison to the substrate.

In the case of the warp yarn already mentioned above, the two measures for implementing the marking stripe can also be easily combined. After all, the warp yarn can be designed so as to have a color that contrasts with the other fabric yarns. Moreover, it is conceivable for the warp yarn to have a larger or smaller diameter than the other warp yarns, for example, thus resulting in a deviation in the surface quality when observed by the assembly worker in the longitudinal extension thereof, in which case the marking is simultaneously a haptic mark.

Moreover, the invention proposes that the marking be a continuous or interrupted spacing mark. In other words, the marking can be designed to be both linear and punctiform. As will readily be understood, combinations are also conceivable and are included by the invention. The spacing stripe is put in place on the substrate or introduced into the substrate at the predefined spacing from the edge covered by the following turn. This covered edge is the respective rear edge (in the wrapping direction) of the adhesive tape wrapped helically around the elongated object or cable bundle.

One will usually proceed such that the spacing in question of the marking stripe from the covered edge is less than 50% of the width of the substrate and particularly less than 30% of the width of the substrate, as was already described above. The consumption of adhesive tape per unit of length of the elongated object to be wrapped can thus be reduced substantially in comparison to previous methods. This also reduces manufacturing costs.

The marking can either be introduced into or applied to the substrate during the manufacture thereof, as was explained previously in relation to the example of the colored warp yarn. It is also possible, however, for the marking to be applied subsequently to the already finished substrate. This can be done before or after or even at the same time as the application of the adhesive coating. For the sake of example and without limitation, the invention recommends the imprinting of the marking stripe, the embossing of the marking, the sewing-on, gluing-on, spraying-on, rolling-on, or even laser application of the marking as conceivable techniques for applying the marking.

As will readily be understood, combinations of the abovementioned techniques are also possible and are included by the invention.

In the case of imprinting, spraying, or rolling, a color that contrasts with the color of the substrate is usually achieved in the area of the marking by applying the desired color onto the substrate. In the case of gluing, a plastic strip can be applied to the substrate as a marking, for example. For sewing, a strip or even a yarn having a contrasting color can also be applied to the substrate or even woven into same.

As a general rule, the method of embossing changes the feel of the substrate in the vicinity of embossed surfaces created in this way, so a haptic mark can be defined on the substrate as a result. With the aid of lasers or comparable structure-altering techniques, it is possible as an alternative or in addition to melt or fuse the substrate with the laser beam guided over it, for example. A change in the coloring can also be achieved in this way, so that, depending on the design, either a colored mark and a haptic mark or both can also be achieved.

As explained previously, the substrate as a whole is a textile planar structure. The substrate can be constructed from a nonwoven, a woven, a warp-knitted fabric, or even velour. As will readily be understood, combinations such as the laminate described above that is based on the flat web and the woven fabric layer. Likewise, the substrate can also be a film.

As a result, an adhesive tape is provided that is especially suitable as a wrapping tape for wrapping an elongated object and is especially predestined in this context for wrapping a cable bundle in a car. The cable bundle realized in this way and wrapped with the adhesive tape in question can be achieved with manufacturing costs that are substantially lower in comparison to the prior art.

In fact, the adhesive tape is equipped for this purpose with the marking as a positioning aid during wrapping that accelerates and renders uniform the wrapping process and minimizes the overlap or overlapping between the leading turn and the following turn glued on same. This accelerates the wrapping process while reducing the consumption of material. Herein lie the fundamental advantages.

The invention is explained in further detail below with reference to a schematic drawing, which illustrates only one embodiment:

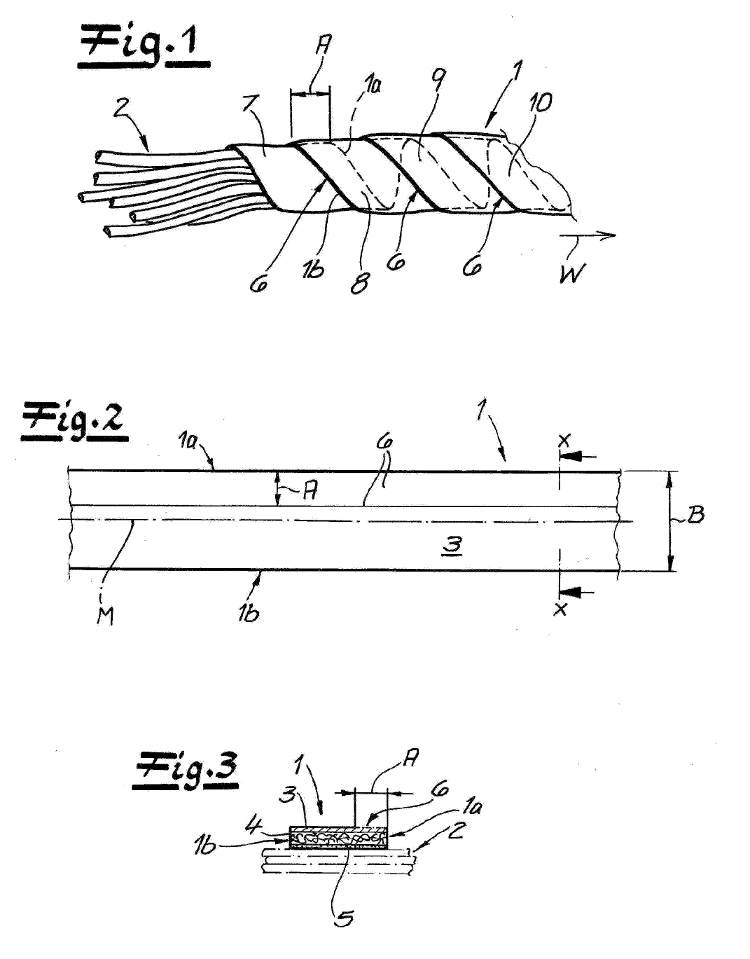

FIG. 1 shows a cable bundle wrapped with an adhesive tape according to the invention;

FIG. 2 shows the adhesive tape according to the invention in the extended state and in a top view, and

FIG. 3 is section x-x through the adhesive tape according to FIG. 2.

FIG. 1 illustrates a cable bundle 2 wrapped with an adhesive tape 1. The cable bundle 2 is composed of several cables grouped together and extending longitudinally. In this way, a cable set is produced as a whole that is typically used in a car. In principle, other elongated objects 2 can also be wrapped with the aid of the adhesive tape 1 according to the invention instead of the cable bundle 2. That is not shown in detail, however.

As can be seen in the section in FIG. 3, the adhesive tape 1 according to the invention has a substrate 3, 4 and an adhesive coating 5. The substrate 3, 4 is composed of a woven fabric layer 3 and a flat web 4 connected thereto. The flat web 4 can be a nonwoven fabric, a velours, or another noise-attenuating layer such as for example a foam layer.

In this embodiment, the adhesive coating 5 is applied to one face of the substrate 3, 4, particularly over the entire surface. In principle, however, the adhesive coating 5 can also be a strip coating as described above. Finally, the substrate 3, 4 is also provided with a marking 6.

It can be seen that the substrate 3, 4 has the adhesive coating 5 on its inner face turned toward the object 2. By contrast, the outer face of the substrate 3, 4 facing away from the object 2 is provided with the previously mentioned marking 6. In this embodiment, and as shown by FIG. 2, the marking 6 is a continuous spacing mark. In fact, the marking 6 has a predefined spacing A from an edge 1a of the adhesive tape 1. Due to its longitudinally extended nature, the adhesive tape 1 has, beside this edge or longitudinal edge 1a, another, opposing or longitudinal edge 1b. Moreover, a center line M can also be seen that divides the adhesive tape 1 in the longitudinal direction into two portions of equal width.

The longitudinal edge 1a of the adhesive tape 1 is an edge 1a of the adhesive tape 1 that is covered during helical wrapping of the adhesive tape 1 onto the elongated object 2 and, for this reason, is shown by a broken line in FIG. 1. In fact, several turns 7, 8, 9, 10, are visible in FIG. 1. The turn 7 is in fact a leading turn 7 of the wrapping or binding achieved with the aid of the adhesive tape 1. On the other hand, the second, adjacent turn 8 acts as a following turn 8 and is glued onto the leading turn 7 with an overlap spacing A. According to the invention, this overlap A corresponds to the spacing A of the marking or, more particularly, spacing mark 6 from the edge 1a of the adhesive tape 1 covered by the following turn 8.

In looking at how the thus performed wrapping or binding of the elongated object—or cable bundle 2 in this case—continues, it becomes clear that all other turns 9, 10 are positioned in a comparable manner on the cable bundle or elongated object 2. In fact, the following turn 8 acts as a leading turn 8 in relation to the following turn 9 subsequent thereto. The following turn 9, in turn, is to be regarded as a leading turn in relation to the other subsequent following turns 10. In all of these cases, the overall procedure followed is that the following turn 8 or 9, 10 is glued to the respective turn 7 or 8, 9 securely glued on the object 2 in consideration of the overlap or overlapping A.

This overlap A is predefined with the aid of the marking 6. After all, the marking 6 is a positioning aid during the described wrapping. This is done in such a way that the following turn 8 or 9, 10 is glued with the overlap A predefined by the marking 6 a positioning aid on the respective leading turn 7 or 8, 9 securely glued on the object 2.

The marking 6 can be embodied overall as a color mark and have a coloring that differs from, particularly contrasts with, a substrate coloring. In fact, the substrate 3, 4 typically has a continuous coloring, for example black. The marking 6 now has a contrasting coloration, for example red, as a color mark. Alternatively or in addition, however, the marking 6 can also be a haptic mark. In this case, the substrate 3, 4 has a different surface quality in the vicinity of the marking 6 than on its remaining surface. This altered surface quality can be realized and implemented, for example, such that the woven fabric layer 3 provided in this case on the outer face of the adhesive tape 1 is blasted with a laser in the longitudinal direction (cf. FIG. 3). In this way, the woven fabric layer 3 in this embodiment can be melted along the laser beam and/or change the coloring of the substrate 3, 4 and, in the present case, of the woven fabric layer 3.

In any case, the marking 6 is defined in this way as a spacing mark and can be used by the assembly worker as a positioning aid during the wrapping process shown in FIG. 1 on the end product. The assembly worker will proceed here effectively by guiding the rear edge 1b of the adhesive tape 1 (when seen in the wrapping direction W) along the marking 6. As a result, the front edge 1a of the adhesive tape 1 (in the wrapping direction W) is automatically covered taking into account the overlap A and defines the edge 1a covered by the respective following turn 8 or 9, 10. This can be seen clearly from the extended view in FIG. 2.

The possibility of working the marking 6 as a whole into the substrate 3, 4 or implementing the marking 6 together with the manufacture of the substrate 3, 4 is not shown. Actually, the approach taken is usually to first precondition the substrate 3, 4 and to provide it beforehand or afterward with the adhesive coating 5. The marking 6 is then applied to this preconditioned substrate 3, 4.

1. An adhesive tape for wrapping an elongated object, the tape comprising:
a substrate,
an adhesive coating applied to at least one face of the substrate, and
a marking serving as a positioning aid during generally helical wrapping of the tape around and along the elongated object, such that a following turn is glued on a preceding turn itself glued securely on the object with an overlap predefined by the positioning aid.

2. The adhesive tape defined in claim 1, wherein the substrate is provided with the adhesive coating over the entire surface of the one face.

3. The adhesive tape defined in claim 1, wherein the substrate is provided on its inner face facing toward the object with the adhesive coating and on its outer face facing away from the object with the marking.

4. The adhesive tape defined in claim 1, wherein the marking is a stripe worked into the substrate as a continuous sewing thread, or is applied to the substrate.

5. The adhesive tape defined in claim 1, wherein the marking is a colored stripe and has a coloring that is different from a color of the substrate color.

6. The adhesive tape defined in claim 1, wherein the marking is haptic and has a feel that differs from a surface quality of the substrate.

7. The adhesive tape defined in claim 1, wherein the marking is a continuous or interrupted stripe that is applied to or introduced into the substrate at a predefined spacing from an edge covered by the following turn.

8. The adhesive tape defined in claim 7, wherein the spacing of the stripe from the covered edge is 50% or less of the width of the substrate.

9. The adhesive tape defined in claim 1, wherein the marking is applied to the substrate by imprinting, embossing, sewing, gluing, laser, spraying, rolling-on, etc., or combinations thereof.

10. The adhesive tape defined in claim 1, wherein the substrate is a textile planar structure made of a nonwoven fabric, warp-knitted fabric, velours, combinations thereof, or a film.

11. An elongated object particularly cable bundle in a car, with a wrapping composed of a leading turn glued securely on the object and a following turn glued with an overlap onto the leading turn, wherein the overlap of the following turn glued on the leading turn is predefined by a positioning aid and each turn is formed by an adhesive tape with a substrate, furthermore with an adhesive coating applied to one or both to faces, and with a marking designed as a positioning aid demarking the overlap.

12. A method comprising:
providing a flexible and elongated tape having a pair of parallel and transversely spaced longitudinal edges, an inner face provided with a layer of adhesive, and an outer face provided with a marking strip extending parallel to and at a predetermined spacing from one of the edges of the tape;
winding the tape generally helically around an elongated object in overlapping turns with the inner face adhered in a leading turn only to the object and in subsequent turns adhered partly to the object and partly to the outer face of preceding turns; and
aligning each turn such that, as it is being applied, it has the one longitudinal edge extending along the stripe and the turn is applied covering substantially all of the preceding turn between the stripe and the other longitudinal edge.
